(19) United States
(12) Patent Application Publication
(10) Pub. No.: US 2025/0271629 A1
(43) Pub. Date: Aug. 28, 2025

(54) TELECOMMUNICATIONS EQUIPMENT INCLUDING SLIDING FIBER ADAPTER MODULES

(71) Applicant: CommScope Technologies LLC, Hickory, NC (US)

(72) Inventors: Kristofer BOLSTER, Jordan, MN (US); Jill Anne MALECHA, New Prague, MN (US)

(73) Assignee: CommScope Technologies LLC, Hickory, NC (US)

(21) Appl. No.: 18/855,470

(22) PCT Filed: Apr. 13, 2023
(86) PCT No.: PCT/US2023/018549

§ 371 Date: Oct. 9, 2024

Related U.S. Application Data
(60) Provisional application No. 63/330,724, filed on Apr. 13, 2022.

(51) Int. Cl. G02B 6/44

(52) U.S. Cl. CPC G02B 6/44524; G02B 6/4455

(57) ABSTRACT

Fiber adapters are mounted on a movable adapter module. The adapters can shift vertically as well as pivot, to provide additional clearance for any selected adapter for improved connector access. An adapter metal clip snaps into a keyhole on the adapter module. The keyhole dimensions allow for vertical movement and pivoting. Notches on the adapter module body are placed (top, middle, and bottom) in support walls that provide strength and allow for pivoting of the adapters.

### CROSS-REFERENCE TO RELATED APPLICATION

This application is being filed on Apr. 13, 2023, as a PCT International application and claims the benefit of and priority to U.S. Provisional Application No. 63/330,724, filed Apr. 13, 2022, the disclosure of which is hereby incorporated by reference in its entirety.

### BACKGROUND

In telecommunications infrastructure installations, equipment for switching, cross-connecting and inter-connecting a variety of panels is used. Many of these panels are installed in telecommunications equipment racks to permit organized, high-density installations to be achieved in limited space available for equipment. Due to the increasing demand for telecommunications system capacity, it is desirable to increase the density of connections within a given space that can be achieved. Commensurate with the demand for increased capacity from the same installation footprint is a desire to improve the organization and handling of the cables used to link the equipment within the installation and the outside plant and facilities cables.

One approach to increasing the density of connections within the same footprint is to increase the number of connections supported within a given panel. Access to these connections within panels of higher densities is necessary for the installation, operation and maintenance of the panels. Preferably, access to any one connection within a panel will not cause unnecessary strain on cables extending from other adjacent connections. Modification of the layout of the interior of these panels to improve connector access is desirable.

### SUMMARY

Fiber adapters are mounted on a movable adapter module. The adapters can shift vertically as well as pivot, to provide additional clearance for any selected adapter for improved connector access.

In one embodiment, the adapter metal clip snaps into a keyhole on the adapter module. The keyhole dimensions allow for vertical movement and pivoting. Notches on the adapter module body are placed (top, middle, and bottom) in support walls that provide strength and allow for pivoting of the adapters.

### BRIEF DESCRIPTION OF THE DRAWINGS

FIG. 1 is a perspective view of a telecommunications equipment rack with two termination panels according to one aspect of the present invention.

FIG. 2 is a front perspective view of the termination panel with an inner pivoting tray in an open position.

FIG. 3 is a front perspective view of the termination panel of FIG. 2, with a hinged cover on the tray in an access position, and one of the sliding adapter modules extended upward.

FIG. 4 is a front view of the termination panel of FIG. 3.

FIG. 5 is an opposite side view of one of the adapter modules of the termination panel of FIGS. 1-4.

FIG. 6 shows an adapter module including an enclosed housing for enclosing fiber optic elements, such as cables, splitters, splices, and wave division multiplexers.

FIG. 7 shows the adapter module of FIG. 6 including front connectors instead of dust caps, and showing at least some of the adapters in pivoted positions.

FIG. 8 shows an alternative adapter module for holding eight fiber adapters.

FIG. 9 is a further view of the adapter module of FIG. 8 showing eight LC duplex adapters mounted to the adapter module, and sixteen LC connectors on the left and right sides of the adapters.

FIG. 10 shows the adapter module of FIG. 9, with some of the adapters shifted vertically upwardly and downwardly for improved connector access.

FIG. 11 shows a top view of the adapter module of FIG. 10 with a notched region in a horizontal support wall.

FIG. 12 is a further view similar to the view of FIG. 7 specifically highlighting the improved access when pivoting of the adapters is permitted.

FIG. 13 shows the adapter module of FIGS. 9 and 10 positioned in a panel of FIGS. 1-4, where eight adapters are positioned in an interior of the panel on the tray, without interference from the hinged cover of pivoting tray of the panel.

FIG. 14 illustrates example dimensions of the keyhole openings for receipt of the metal clip of each adapter.

FIG. 15 shows in an enlarged view the amount of movement of the upper adapter in the adapter module from a lower position to an upper position.

FIG. 16 is a further view of a modified adapter module for eight adapters, and shown without any adapters.

FIG. 17 is a further view of the adapter module of FIG. 16 with eight LC duplex adapters and mated LC connectors, including one adapter in exploded view.

FIG. 18 is a side view of the adapter module and adapters with connectors of FIG. 17.

FIG. 19 is a cross-sectional elevation view of the adapter module of FIGS. 13-18.

### DETAILED DESCRIPTION

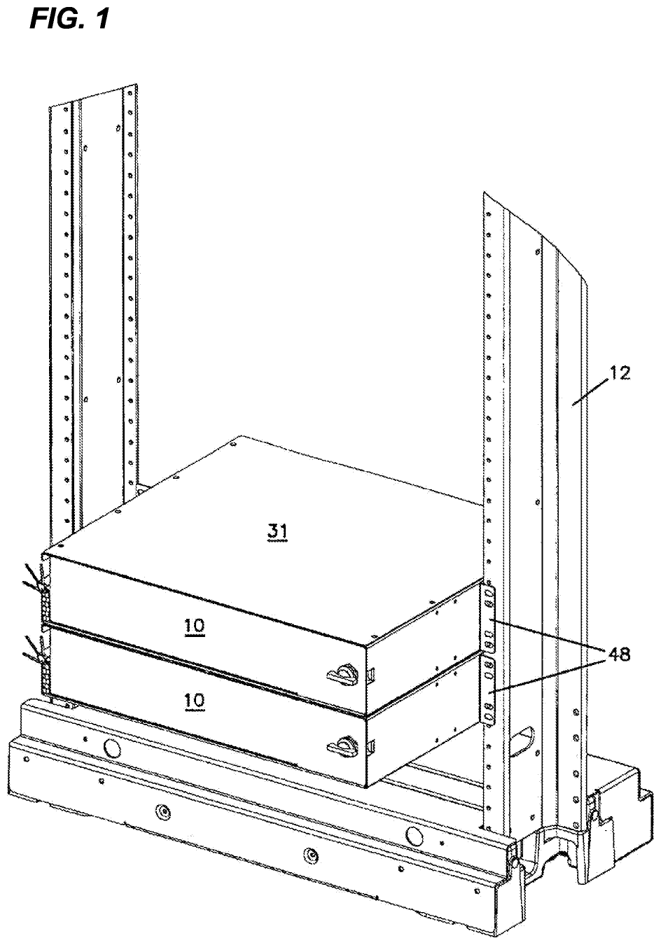

FIG. 1 shows two telecommunications termination panels 10 mounted to a telecommunications equipment rack 12. Mounting brackets 48 on each panel 10 allow for the panels to be mounted to the rack.

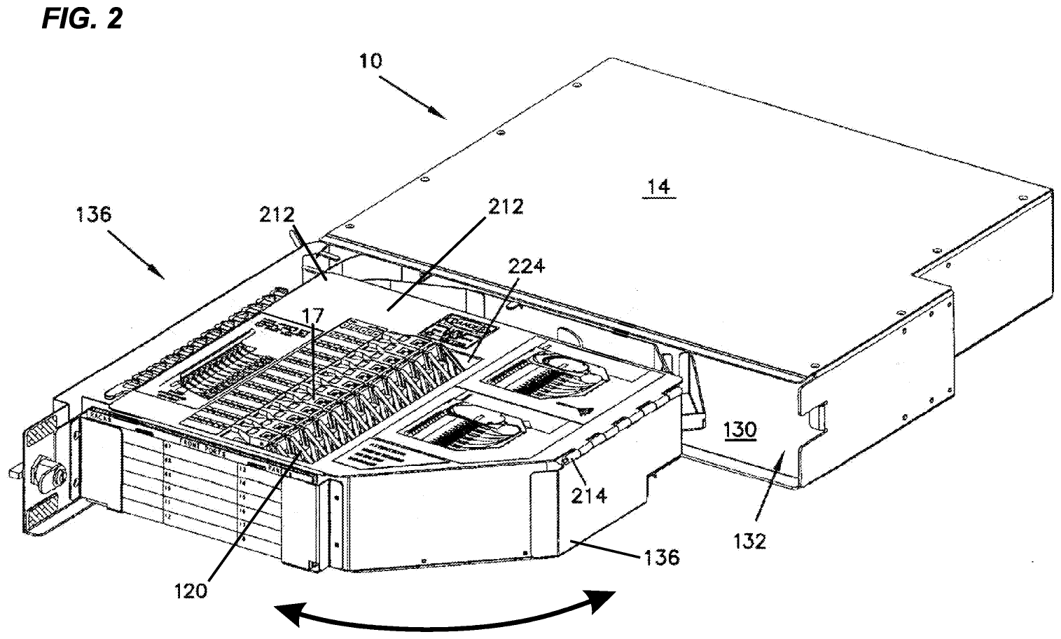

FIGS. 2-4 show additional features of panel 10. A pivoting tray 136 swings out from an interior 130 of panel housing 14 through opening 132. Fiber optic adapters 16 are mounted in a sliding module 17 which is slidably mounted vertically in a framework structure 120 on tray 136, such as on a base of the tray. Tray 136 also includes a cover 212 hingedly mounted to the pivoting tray 136 by hinge 214. The cover 212 is positionable over the adapters 16, adapter modules 17, and the mounting framework structure 120. Cover 212 has an opening 224 that allows an upper portion of the adapter modules 17 and the framework structure to protrude through the opening 224.

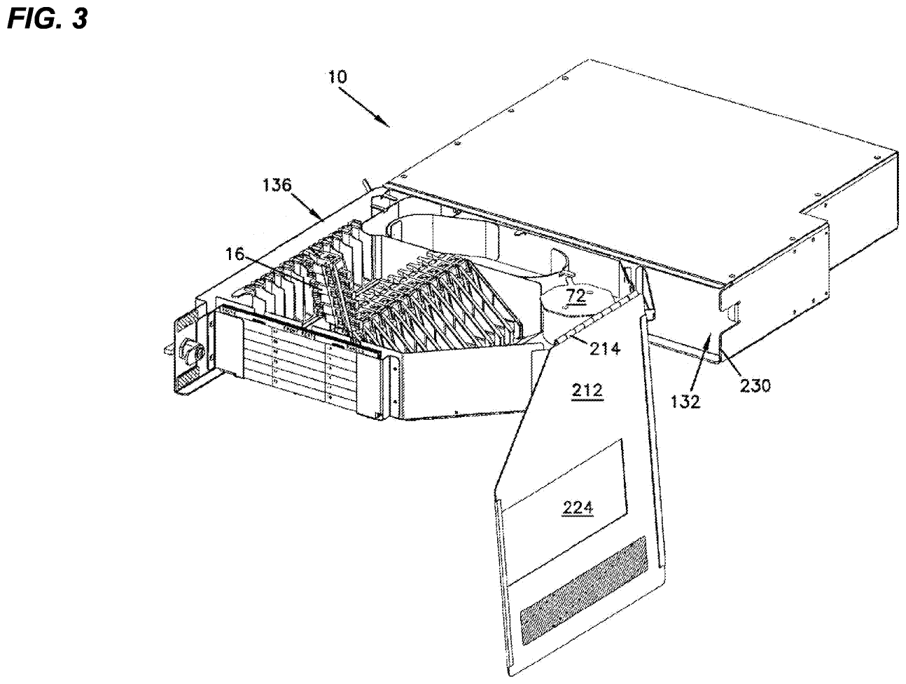

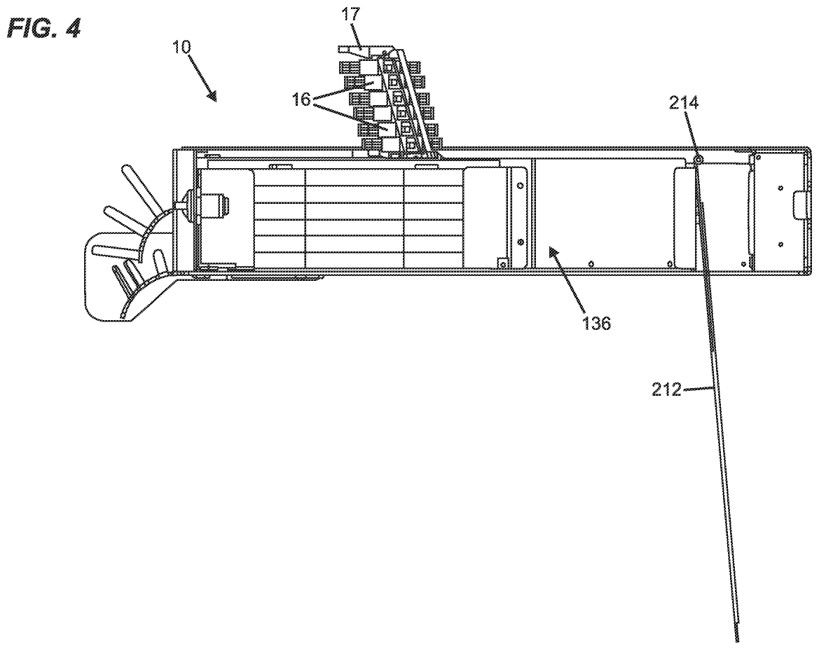

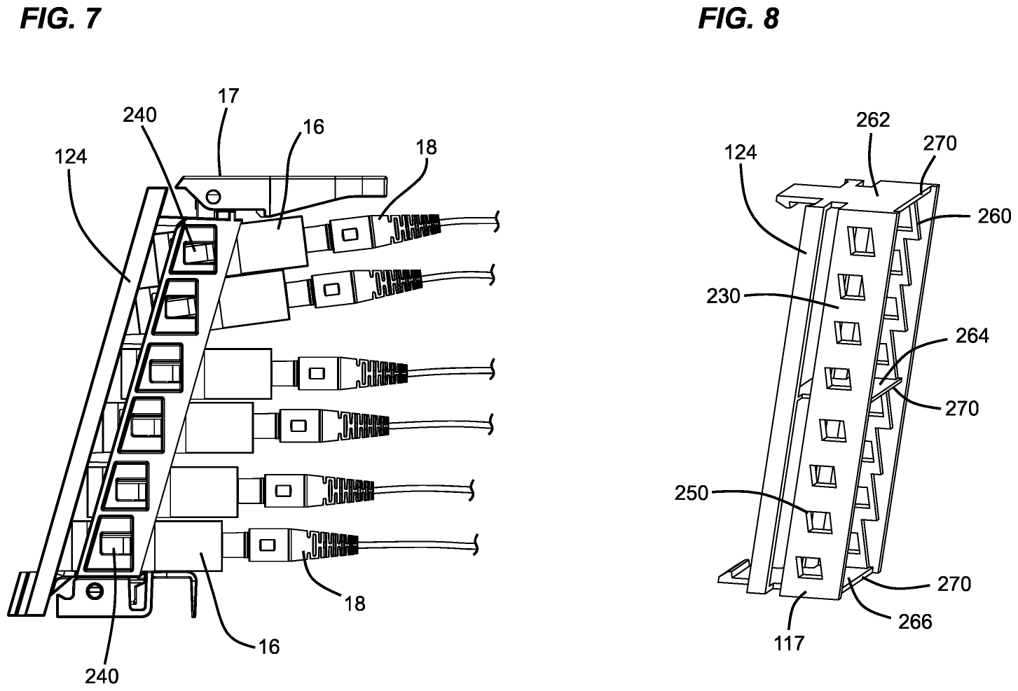

FIGS. 3 and 4 show one of the adapter modules 17 in an extended position for accessing individual connectors 18 (see FIG. 7) connected to each other through the adapters. Further details of sliding adapter modules 17 of the type shown in FIGS. 2-4 are shown in U.S. Pat. Nos. 7,408,769 and 6,591,051, the disclosures of which are hereby incorporated by reference.

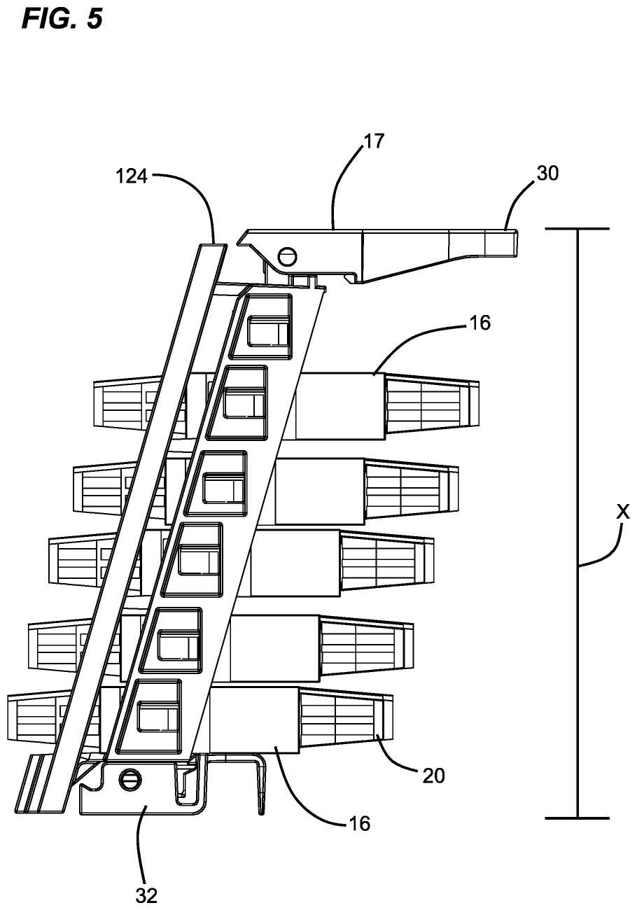

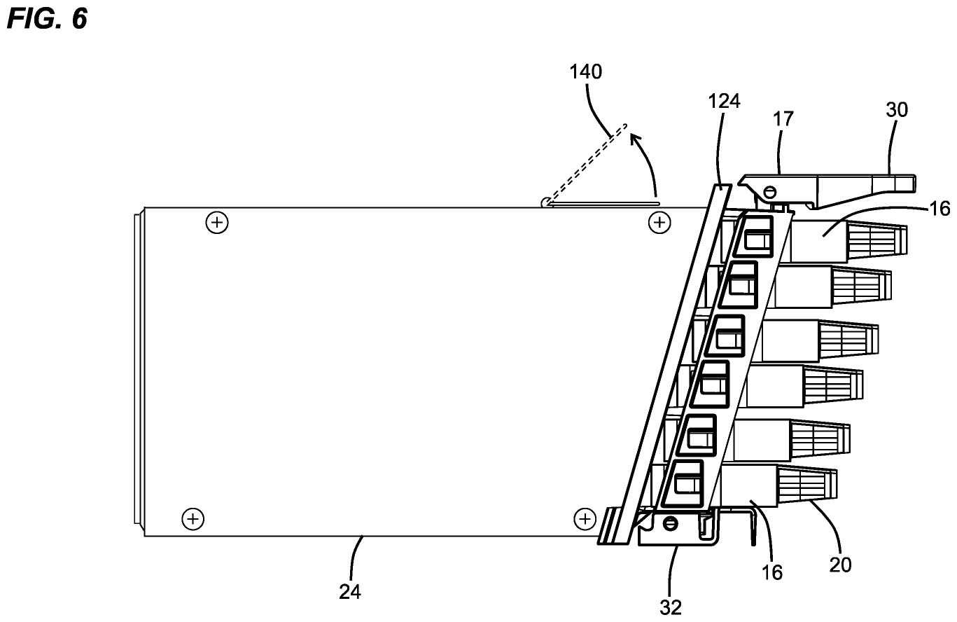

FIGS. 5 and 6 show two adapter modules 17 of a similar construction. Dust caps 20 are provided for protecting the open ports of each adapter 16 until connectors 18 with cables are provided. FIG. 6 shows a housing construction 24 attached to the adapter module 17 for housing internal connectors on the left side of the adapter modules 17, cables, and other structures including splitters, splices, and wave division multiplexers. Adapters 16 of FIGS. 5 and 6 are SC type adapters for use with SC type connectors.

FIG. 7 shows fiber LC connectors 18, two per LC adapter 16 extending from a right side of each adapter. FIGS. 5-7 show that the adapter module 17 includes six adapters 16. FIGS. 5-7 also show an upper latch 30, and a lower lock 32 for use with the framework structure 120 during retention and selective sliding of each adapter module 17. FIG. 7 further shows the adapters 16 being pivotable relative to each other so as to improve finger access to the connectors, and the connector latches, in this case LC latches.

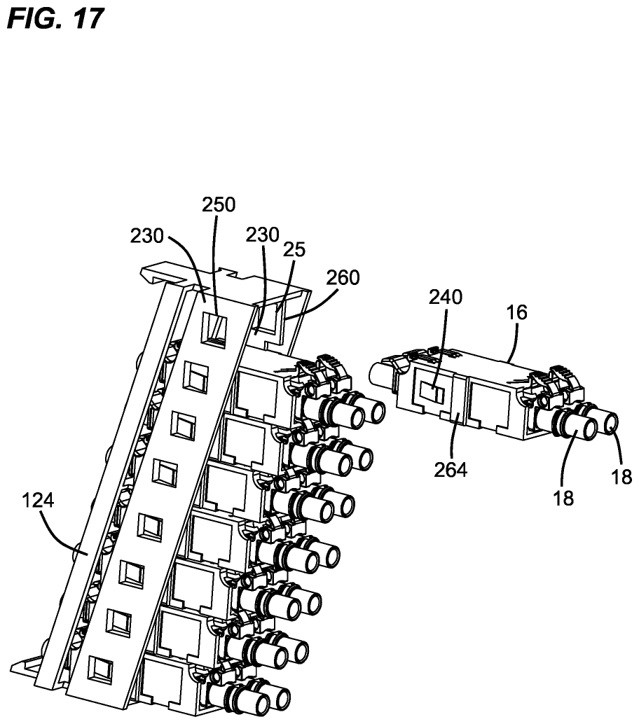

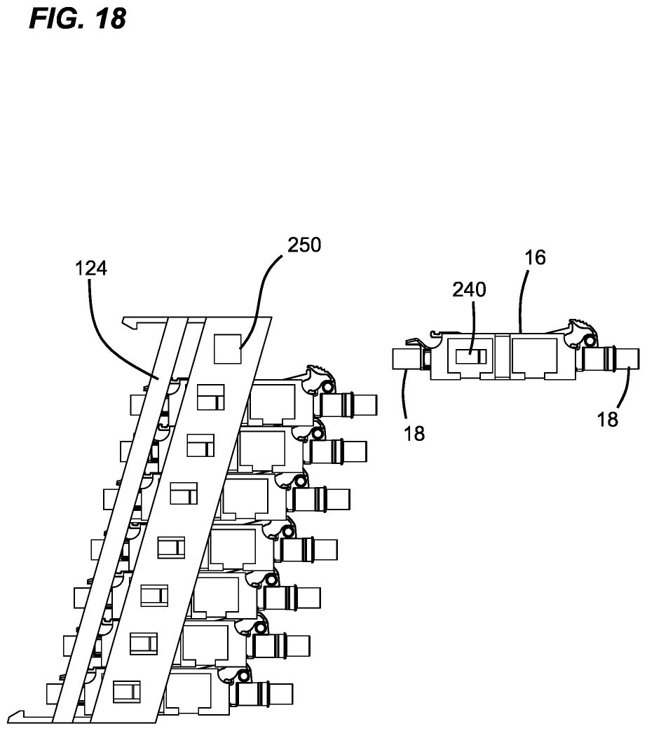

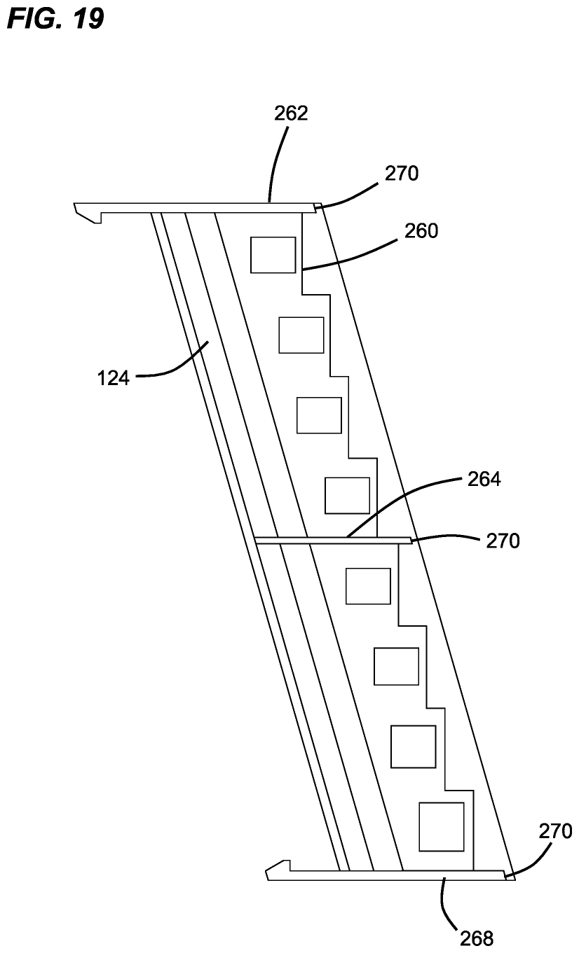

FIGS. 8-10 show a modified adapter module 117 for holding eight LC adapters 16. In one example, the same vertical height “X” of the adapter module 17 shown in FIGS. 5-7 is achieved by the adapter modules 117 of FIGS. 8-11. One modification in the adapter module of FIGS. 8-11 is the removal of the upper latch 30, and the lower lock 32. The adapter module of FIGS. 8-11 is designed to slide in a similar manner as the adapter modules of FIGS. 5-7 on a rail system as noted above with respect to FIGS. 2-4. Adapter modules 117 therefore have a higher density (8 fiber adapters compared to 6 fiber adapters) relative to adapter modules 17. Rails 124 are shown in FIGS. 5-8, and 15-19. These rails 124 allow for sliding movement with respect to the framework structure 120.

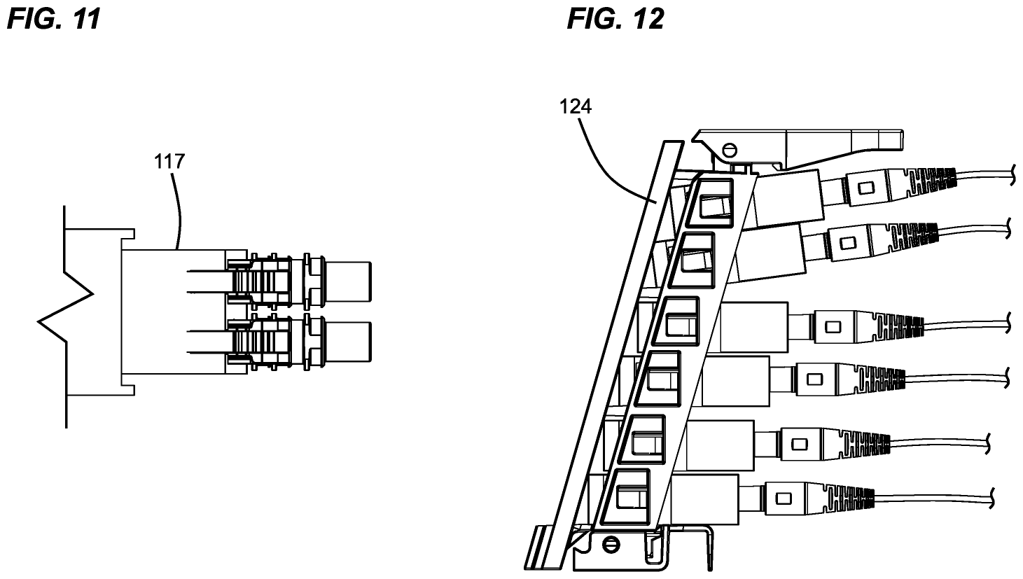

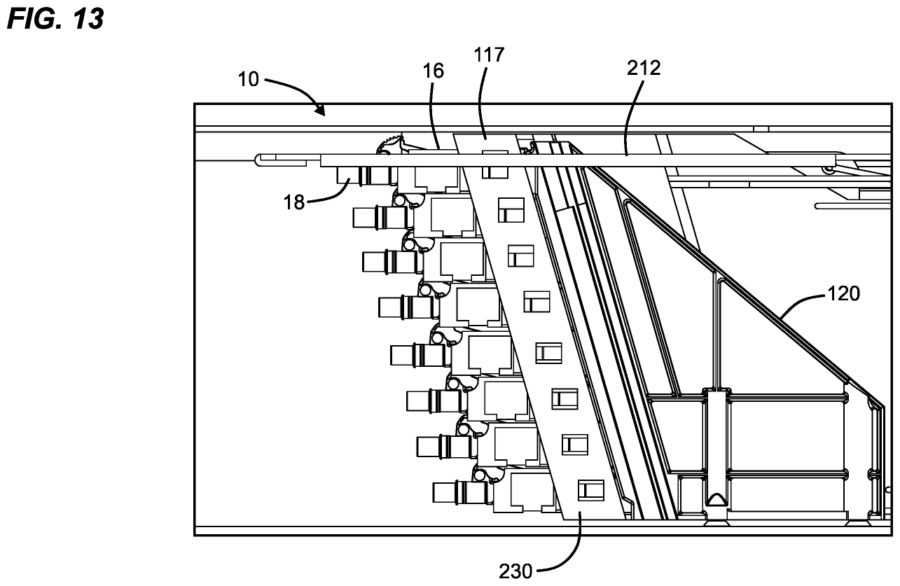

Adapters 16 of adapter modules 117 can shift vertically as well as pivot, to provide additional clearance for any adapter for connector access. For example, in FIG. 10, the top two adapters 16a, 16b are shifted upwardly, and adapter 16d is shifted downwardly, providing additional clearance for access to the selected adapter 16c. The 8 adapter module 117 also allows the adapters 16 to pivot as shown in FIG. 12.

The adapters 16 mount to the adapter module 117 by sliding the adapter 16 along the adapter/connector axis relative to the adapter module 117. An adapter metal clip 240 on each side of the adapter 16 snaps into a keyhole 250 in each of the opposed sidewalls 230. The keyhole dimensions allow for vertical movement and pivoting. Notches 270 on the adapter module body are provided (top wall 262, middle wall 264, and bottom wall 266) to allow for pivoting of the adapters without compromising the mounting of the adapters in each location. Flange 264 on adapter 16 engages shoulder 260 on each sidewall 230 to limit sliding of adapter 16 to far into the desired location in adapter module 117. Metal clips are shown in U.S. Pat. No. 5,31,663, the disclosure of which is hereby incorporated by reference

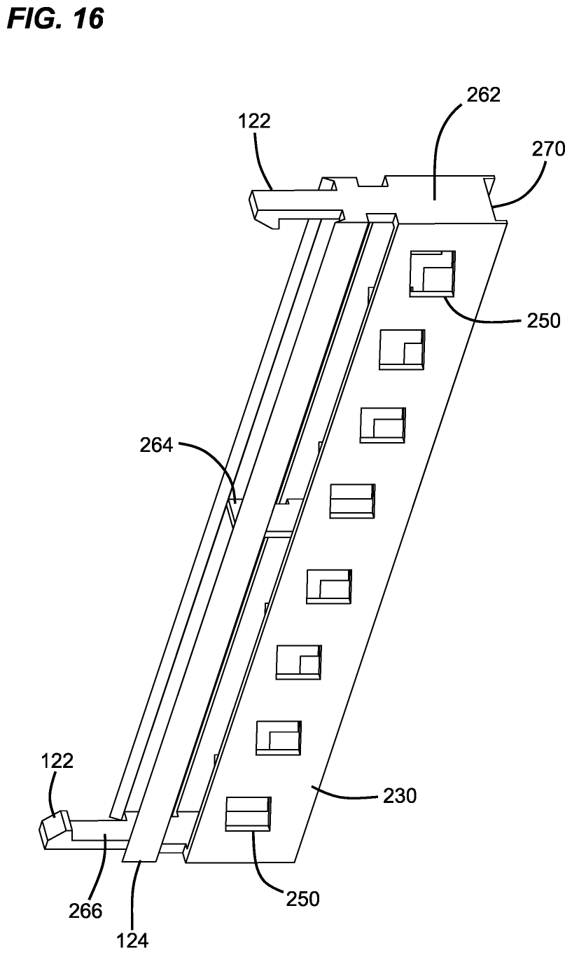

Referring now to FIGS. 16-18, adapter module 117 has flexible clips 122 for mounting to an enclosed housing construction 24, such as shown in FIG. 6. Since adapter module 117 in the illustrated example no longer has an upper latch, a handle 140 could be added to the housing construction 24, such as shown in FIG. 6.

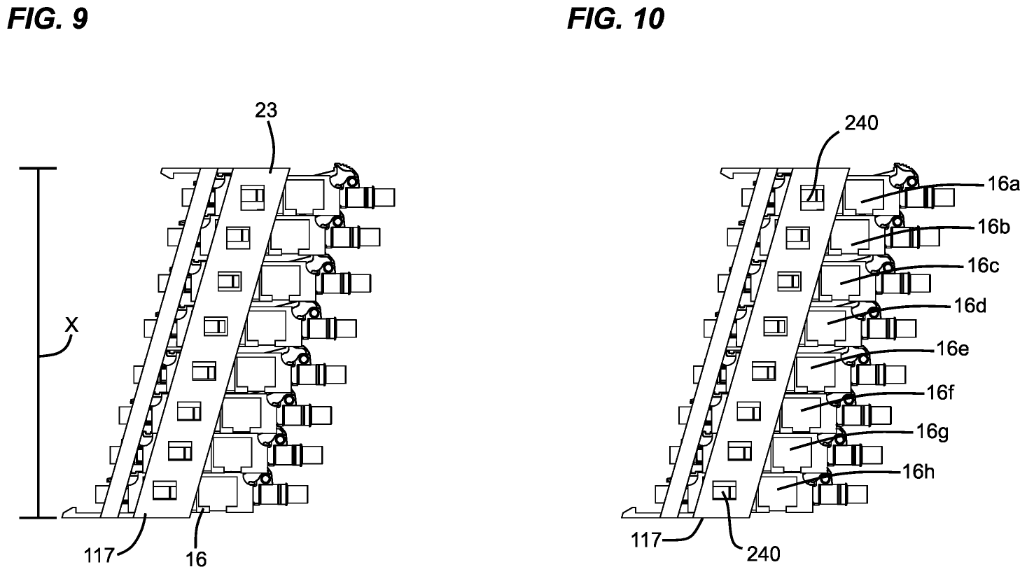

As noted above, dimension X for the six position adapter module 17 (see FIG. 5) is the same as dimension X of the eight position adapter module 117 (see FIG. 9). This has the effect of increasing the connector density of panel 10 without changing other features of panel 10 other than the adapter module 117.

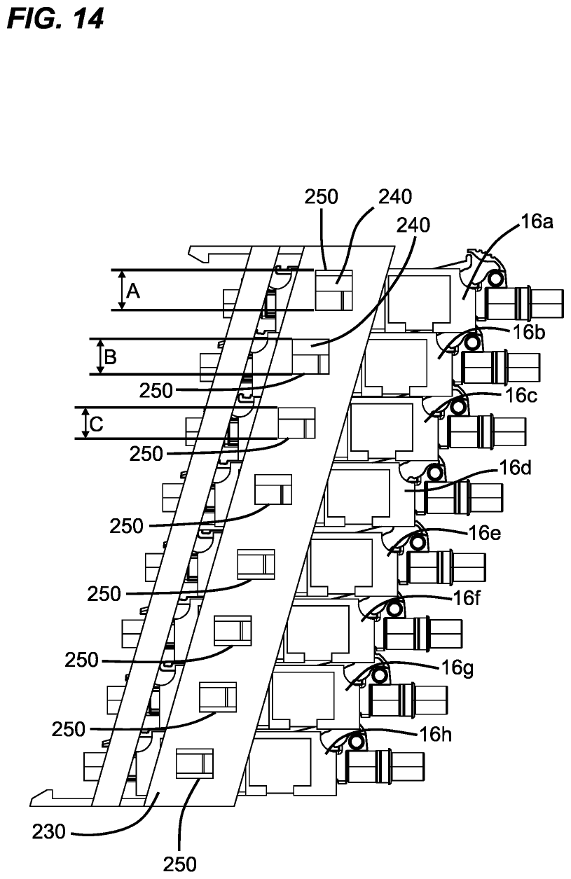

To address connector access issues, a height dimension of each keyhole 250 is provided such that each adapter can be moved vertically (see FIG. 10). This increased height also allows for more rotate ability like shown in FIG. 12. In one example, a height of metal clip 240 for the spring portion is approximately 0.11 inches. As shown in FIG. 14, the minimum height of the keyhole 250 is 0.170 inches, Dimension C. This allows for vertical movement to create spacing for finger access to reach the latch of each connector. This also allows for some rotatability wherein there is a slight gap due tolerances in the horizontal direction such that pivoting of the adapter is also permitted. As shown in this example, keyholes 250 below the mounting location of connector 16c also have the same Dimension C.

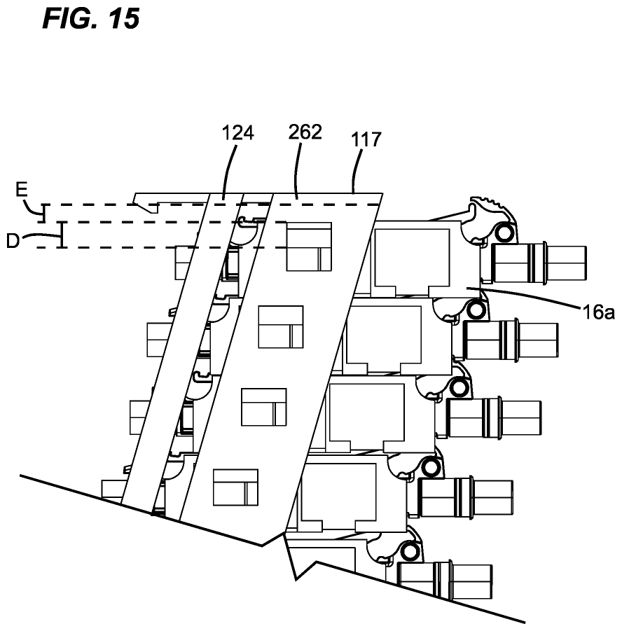

With further reference to FIG. 14, some of the keyholes 250 can be provided with a further increased height to permit additional vertical movement. As shown, the upper two keyholes 250 have a greater dimension (example 0.230 inches Dimension A, and 0.200 inches Dimension B) relative to the others which are noted as example 0.170 inches. This allows for the upper adapter 16a to move a maximum of approximately example 0.119 inches Dimension D from a lowermost position with respect to the keyhole 250. As shown in FIG. 15, due to the construction of the adapter module 117 and top wall 262, the uppermost adapter can move about 0.085 inches up and down Dimension E. This allows for reduced interference with cover 212, and still allows eight adapters. But when access is desired to lower adapters, the larger keyholes permit upper and lower spacings to occur (see FIG. 10). It should be noted that middle wall 264 prevents downward movement of adapter 16d, and it limits upward movement of adapter 16e. Within each of the two groupings of four adapters, access is increased by using the larger keyholes relative to the spring clip height. For example, at least 0.030 inches greater, at least 0.040 inches greater, at least 0.040 inches greater, at least 0.060 inches greater, at least 0.070 inches greater, at least 0.090 inches greater, and at least 0.120 inches great. In some cases the heights can all be the same for the keyholes, or they can be graduated, such as 0.170, 0.200, and 0.230 inches.

Adapter module 117 increases density (eight compared to six adapter positions) relative to adapter module 17, without increasing the overall height of the adapter module 117. Adapter module 117 does not create interference with a panel construction such as shown in U.S. Pat. No. 7,4087,699, noted above. Further, adapter module 117 provides increased finger access for connectors with latches requiring finger contact to delatch the connector (example LC) by allowing for increased vertical movement of individual selected adapters. Adapter module 117 also allows for pivoting movement of adapters to further increase finger access.

1. Telecommunications equipment comprising:
a base;
a movable adapter module mounted to the base;
a plurality of fiber adapters in a column mounted on the movable adapter module, wherein the adapters can shift vertically and pivot, relative to the column, to provide additional clearance for any selected adapter for improved connector access.

2. The telecommunications equipment of claim 1, wherein an adapter metal clip snaps into a keyhole on the adapter module, wherein the keyhole dimensions allow for vertical movement and pivoting.

3. The telecommunications equipment of claim 1, wherein notches on the adapter module body are placed (such as top, middle, and bottom) in transvers support walls that provide strength and allow for pivoting of the adapters.

4. The telecommunications equipment of claim 1, wherein the adapter module further includes a housing construction for holding telecommunications components.

5. The telecommunications equipment of claim 4, further comprising a handle mounted to the housing construction.

6. The telecommunications equipment of claim 1, further comprising a termination panel 10, including mounting brackets for mounting the panel to a rack.

7. The telecommunications equipment of claim 6, wherein the termination panel includes a moveable tray movable relative to an interior of a panel housing through an opening, wherein the fiber adapters are mounted in a sliding adapter module which is slidably mounted vertically in a framework structure on the tray, wherein the tray further includes a cover hingedly mounted to the tray by a hinge, the cover positionable over the fiber adapters, the adapter modules, and the mounting framework structure.

8. The telecommunications equipment of claim 7, wherein the cover has an opening that allows an upper portion of the adapter modules and the mounting framework structure to protrude through the opening.
